(19) United States
(12) Patent Application Publication
(10) Pub. No.: US 2026/0367967 A1
(43) Pub. Date: Nov. 19, 2026

(54) METHODS AND SYSTEMS FOR PROCESSING LONG SERVICE TASKS

(71) Applicant: Shopify Inc., Ottawa (CA)

(72) Inventors: Marc-André Cournoyer, Montréal (CA); Yeji Park, Toronto (CA); Josh Teeter, New Hamburg (CA); Francisco Mejia, Ottawa (CA)

(21) Appl. No.: 19/211,052

(22) Filed: May 16, 2025

(51) Int. Cl. G06F 9/48; G06F 9/52

(52) U.S. Cl. CPC G06F 9/4881; G06F 9/52

(57) ABSTRACT

A computer-implemented method, including, for a first task, performing a wait operation to acquire a first semaphore; after acquiring the first semaphore, determining that the first task includes a long running operation; responsive to determining that the first task includes the long running operation, performing a wait operation to acquire a second semaphore; after acquiring the second semaphore, releasing the first semaphore and performing the long running operation; responsive to completion of the long running operation releasing the second semaphore.

### FIELD OF THE DISCLOSURE

The present disclosure is related to the processing of tasks, and in particular relates to the concurrent processing of tasks.

### BACKGROUND

A server or computing device may be configured to execute tasks at worker processes as they arrive at the server. Often such server has the ability to process a limited number of tasks concurrently. For example, such number of concurrent tasks can be predetermined, and may in some cases be limited to only one task at a time.

The tasks being processed by the server may therefore be gated, with tasks over the threshold number of concurrent tasks capable of being processed being blocked or queued for future processing. This can, for example, be done through a gating algorithm such as a semaphore.

### SUMMARY

A server may be gated to allow only a predetermined number of concurrent operations. However, if the nature of the operations is unknown ahead of time, long running operations may clog the system, for example waiting for responses to remote system calls. This may cause the overall operation of the system to slow and may cause processors at the server to go unused or become idle, thereby wasting resources.

In this regard, in accordance with the embodiments of the present disclosure, after an operation is accepted as one of the allowed concurrent processes at the server, it may be evaluated to determine whether it is a short or long running operation.

Once it is determined that the operation is a long running operation, it may be moved into a separate, long_task processing area, i.e for a long running worker process. This may be done by acquiring a semaphore for the long_task processing area and then releasing the standard operation processing semaphore. This may free the primary resources for processing more tasks.

Once the long running operation is completed, the task may be returned to the primary processing resources to complete processing of the task. Such system may reduce bottlenecks in the system, thereby improving system performance, reducing wasted resources, and improving system efficiency.

Therefore, in one aspect, a computer-implemented method may be provided. The computer-implemented method may, for a first task, perform a wait operation to acquire a first semaphore, and after acquiring the first semaphore, them method may determine that the first task includes a long running operation. The method may further, for the first task and responsive to the determining that the first task includes the long running operation, perform a wait operation to acquire a second semaphore. The method may, after acquiring the second semaphore, release the first semaphore and perform the long running operation. Upon completion of the long running operation, the method may release the second semaphore.

In some embodiments, the method may further include, prior to determining that the first task includes a long running operation, beginning the first task.

In some embodiments, the beginning the first task may consist of performing at least a portion of the first task.

In some embodiments, the performing at least a portion of the first task may consist of performing one or more short running operations.

In some embodiments, the one or more short running operations are processor-bound operations.

In some embodiments, the method may further include reacquiring the first semaphore to complete the first task upon releasing the second semaphore, and after completing the first task, releasing the first semaphore.

In some embodiments, completing the first task includes performing at least a portion of the first task.

In some embodiments, the performing at least a portion of the first task includes performing one or more short running operations.

In some embodiments, the long running operation is an input or output bound operation.

In some embodiments, the first task consists of the long running operation.

In some embodiments, the first task including the long running operation is determined based on a flag indicating that the first task includes the long running operation.

In some embodiments, the determining that the first task includes the long running operation includes determining that the first task has taken a greater than threshold amount of time.

In some embodiments, the reacquiring the first semaphore places the first task at the beginning of a queue for the first semaphore.

In some embodiments, the computer-implemented method is performed on a web server.

In a further aspect, a computing device having a processor and memory may be provided. The computing device may be configured to, for a first task, perform a wait operation to acquire a first semaphore and, after acquiring the first semaphore, determine that the first task includes a long running operation. The computing device may further be configured to, responsive to determining that the first task includes the long running operation, perform a wait operation to acquire a second semaphore, and after acquiring the second semaphore, release the first semaphore and perform the long running operation. The computing device may further be configured to, responsive to completion of the long running operation, release the second semaphore.

In some embodiments, the computing device may further be configured to, prior to determining that the first task includes a long running operation, begin the first task;

In some embodiments, the computing device may be configured to begin the first task by performing at least a portion of the first task.

In some embodiments, the performing the at least a portion of the first task may consist of performing one or more short running operations.

In a further aspect, a non-transitory computer readable medium for storing instruction code may be provided. The instruction code, when executed by a processor of a computing device, may cause the computing device to, for a first task, perform a wait operation to acquire a first semaphore and, after acquiring the first semaphore, determine that the first task includes a long running operation. The instruction code, when executed by a processor of a computing device, may further cause the computing device to, responsive to determining that the first task includes the long running operation, perform a wait operation to acquire a second semaphore, and after acquiring the second semaphore, release the first semaphore and perform the long running operation. The instruction code, when executed by a processor of a computing device, may further cause the computing device to, responsive to completion of the long running operation, release the second semaphore.

### BRIEF DESCRIPTION OF THE DRAWINGS

The present disclosure will be better understood with reference to the drawings, in which:

FIG. 1 is a block diagram of an example computing system, which may be used to implement examples of the present disclosure.

FIG. 2 is a block diagram showing an example of the use of a semaphore for gated access to a resource.

FIG. 3 is a block diagram showing an example of the use of a semaphore for gated access to a plurality of resources.

FIG. 4 is a block diagram showing first semaphores for access to first resources, and second semaphores for access to second, long running resource.

FIG. 5 is a process diagram showing a process for moving tasks having long running operations out of primary resources to secondary resources for processing the long running tasks.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

A server may receive a heterogeneous set of tasks or operations to execute. For example, some operations may be central processing unit (CPU)-bound and thus be relatively quick to execute. Other operations may be Input/Output (I/O) type operations, which require a call to a network, disk, or other input or output, among other options, and therefore may cause delays at the server while waiting for the I/O operation to execute and return a result. Other operations may equally cause delays at the server.

In many cases, the nature of the operation, and whether it will be a short processing operation or a long processing operation, is unknown ahead of time. Thus, a server can only determine the nature of the operation after it has been accepted by the server.

A server may be gated to allow only a predetermined number of concurrent operations. This may, for example, use a semaphore or similar algorithm. If only one operation/request is allowed at a time, the semaphore may be referred to as a mutex. Such semaphore may limit the number of concurrent tasks, for example to avoid race conditions.

However, if the nature of the operations is unknown ahead of time, long running operations may clog the system, for example waiting for responses to remote system calls. This may cause the overall operation of the system to slow and may cause processors at the server to go unused or become idle, thereby wasting resources.

In this regard, in accordance with the embodiments of the present disclosure, after an operation is accepted as one of the allowed concurrent processes at the server, it may be evaluated to determine whether it is a short or long running operation.

In some cases, the evaluation may be based on flags or markers in the code to indicate that the operation is a long running operation.

In some cases, the evaluation may be based on parsing the operation and comparing the operation to previously defined long or short running operations. For example, processor bound operations may be flagged as short running operations, whereas disk read functions, the calling of a network stack function, among similar operations, may be flagged as long running operations.

In some cases, the evaluation may be based on the amount of time an operation has already taken at the server. Thus, if the operation has consumed a threshold amount of time, it may be classified/re-classified as a long running operation.

In some cases, the evaluation may be based on a defined sequence of events. For example, if a call for information is made first to a cache, and an indication of a cache miss is received back, then the information may need to be obtained from another source, and the operation may be considered a long running operation. More generally, the acquiring of the first semaphore and the detection of an event or condition may cause the process to consider the operation a long running operation.

Other options for the evaluation are possible.

Once it is determined that the operation is a long running operation, it may be moved into a separate, long_task processing area, i.e. for a long running worker process. This may be done by acquiring a semaphore for the long_task processing area and then releasing the standard operation processing semaphore. In some cases, the long_task processing area may be configured to accept more concurrent processes than the standard operation processing area. For example, the standard operation processing area may have one, two or three concurrent operations, while the long_task processing area may allow ten or more concurrent operations. Other configurations for the number of concurrent operations in each processing area are however possible.

In some cases, once information is received or processing is completed for a long running operation, the long running operation may be put back into the queue for the standard processing area to complete the operation. For example, the I/O bound operation may be completed by a long_task worker process, and remaining CPU-bound processing may still need to be completed. In this case the process may again request access to the standard worker processes. This means the operation would have to wait for the next standard semaphore to be free for the completion of the processing.

In some cases, the long running operation may be put at the beginning of the queue for standard processing to reduce delays on the operation. In some cases, the long running operation may be put at the end of the queue for standard processing, thereby avoiding delays on already queued operations.

In some cases, once the processing for the long running operation is complete, the operation may be complete and the semaphore for the long running operation may be released for use by other long running operations.

The above is described below with regard to the drawings.

### Computing Device

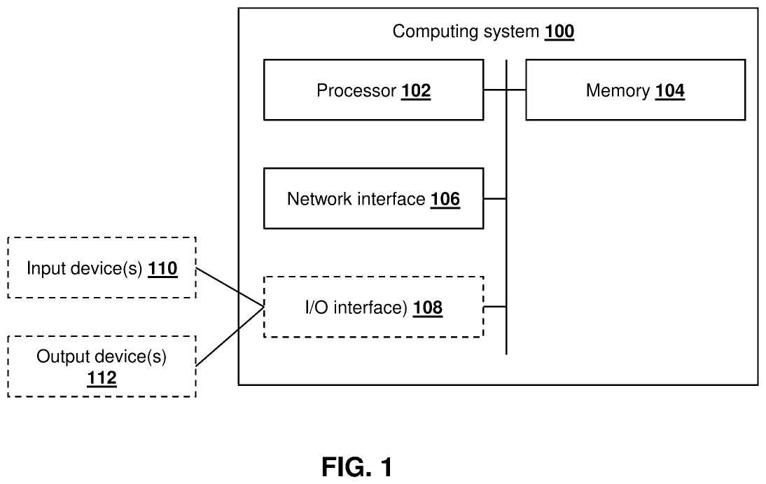

FIG. 1 illustrates an example computing system 100, which may be used to implement examples of the present disclosure, such as a the use of first and second semaphores to manage long running operations and short running operations. Additionally or alternatively, one or more instances of the example computing system 100 may be employed. For example, a plurality of instances of the example computing system 100 may cooperate to process the long running operations and short running operations.

The example computing system 100 includes at least one processing unit, such as a processor 102, and at least one physical memory 104. The processor 102 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 104 may include a volatile or non-volatile memory (e.g., a flash memory, a random access memory (RAM), and/or a read-only memory (ROM)). The memory 104 may store instructions for execution by the processor 102, to the computing system 100 to carry out examples of the methods, functionalities, systems and modules disclosed herein.

The computing system 100 may also include at least one network interface 106 for wired and/or wireless communications with an external system and/or network (e.g., an intranet, the Internet, a Person to Person (P2P) network, a Wide Area Network (WAN) and/or a Local Area Network (LAN)). A network interface may enable the computing system 100 to carry out communications (e.g., wireless communications) with systems external to the computing system 100.

The computing system 100 may optionally include at least one input/output (I/O) interface 108, which may interface with optional input device(s) 110 and/or optional output device(s) 112. Input device(s) 110 may include, for example, buttons, a microphone, a touchscreen, a keyboard, a network card, etc. Output device(s) 112 may include, for example, a display, a speaker, etc. In this example, optional input device(s) 110 and optional output device(s) 112 are shown external to the computing system 400. In other examples, one or more of the input device(s) 110 and/or output device(s) 112 may be an internal component of the computing system 100.

A computing system, such as the computing system 100 of FIG. 1, may access a remote system (e.g., a cloud-based system) to communicate with the remote system, for example, using an application programming interface (API) call. The API call may include an API key to enable the computing system to be identified by the remote system.

While the computing system of FIG. 1 provides an example computing system, in practice the computing system used with the methods and apparatus herein can be any computing system and can include more or fewer components than those described in FIG. 1. The example computing system of FIG. 1 is therefore provided only for illustration.

In some embodiments, computing system 100 may be a web server. However, other environments are also possible.

### Semaphores

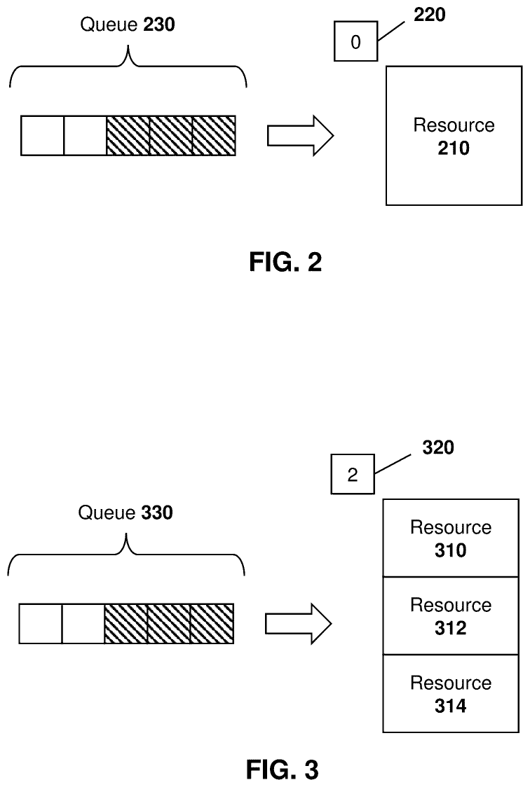

The present disclosure is described herein with regard to semaphores. Generally, a semaphore is a variable or abstract data type used in the control of access to a common resource by multiple treads, and is a type of synchronization primitive. The term semaphore, as used herein, provides for generalized access control to a resource, and is not limited to any particular access control implementation. The examples semaphores with regard to FIGS. 2 and 3 are provided for illustrative purposes.

A “thread” is a series of programmed instructions that can be managed by an operating system scheduler, and is a component of a process. A thread can also be referred to herein as a task or operation, and the terms are used interchangeably.

Reference is now made to FIG. 2, which shows a semaphore implementation having a single resource. In some cases, the use of a single resource can be implemented with a binary semaphore and may also be referred to as a mutex.

Thus, in the example of FIG. 2, a single resource 210 can be used for multiple threads or operations. In this case, a flag or semaphore 220 can be used to control access to resource 210. For example, with a single resource, semaphore 220 could be a binary digit. In other cases, it could be an integer. Other options are possible.

When a thread or operation needs to use the resource, it checks semaphore 220. This may, for example be done with a wait operation P( ). For example, if semaphore 220 is implemented as an integer, the wait operation P( ) may decrement the semaphore 220 as long as such semaphore is greater than zero. In this case the thread or operation takes control of the resource 210.

If semaphore 220 is a negative integer already, the thread or operation is placed into the semaphore queue 230 to wait until resource 210 becomes free.

However, the wait operation may use other criteria to determine if the resource is free. For example, in a mutex, a “1” may indicate the resource is free and a “0 ” may indicate the resource is busy. With integers, a positive number may indicate the resource is free, while a zero or negative number may indicate the resource is busy. Other options are possible.

Typically semaphore queue 230 is a first in, first out type queue, meaning that threads or operations are performed in the order that they arrive to use the resource.

Once resource 210 is finished with the thread or operation, it may perform a signal or up operation V( ), which may increment the value of semaphore 220. Thus, for example, the signal operation may toggle the semaphore from “0 ” to “1” if the semaphore is a binary digit to indicate that resource 210 is now available. If the semaphore 220 is implemented using integers, the signal operation may increment the value of semaphore 220. Other options for the signal operation V( ) are also possible.

The next item on semaphore queue 230 (if any) may then be provided to resource 210 and the wait operation P( ) may again be implemented.

While the example of FIG. 2 provides for a semaphore for a single resource, in some cases the semaphore may control access to multiple resources. Reference is now made to FIG. 3.

In the example of FIG. 3, a plurality of resources, shown as resources 310, 312 and 314, may be provided for threads or operations. However, the selection of three resources in the example of FIG. 3 is merely provided for illustrative purposes, and in practice a system could have more or fewer resources gated by a semaphore 320.

When a thread or operation needs to use a resource, it checks semaphore 320. For example, if semaphore 320 is implemented as an integer, a wait operation P( ) may decrement the semaphore 320 as long as such semaphore is greater than zero. In this case the thread or operation takes control of a free resource from resources 310, 312 and 314.

Thus, in one example, semaphore 320 starts at a value of “2” and is decremented. When it becomes negative, this indicates that all resources 310, 312 and 314 are busy. However, this is merely one example, and other options are possible.

If semaphore 320 is a negative integer already, the thread or operation is placed into the semaphore queue 330 to wait until a resource from resources 310, 312 and 314 becomes free.

However, the wait operation may use other criteria to determine if the resource is free. For example, a positive number may indicate the resource is free, while a zero or negative number may indicate the resource is busy. Other options are possible.

Typically semaphore queue 330 is a first in, first out type queue, meaning that threads or operations are performed in the order that they arrive to use the resource.

Once a resource from resources 310, 312 or 314 is finished with the thread or operation, it may perform a signal or up operation V( ), which may increment the value of semaphore 320. Thus, for example, the signal operation may increment the value of semaphore 320. Other options for the signal operation V( ) are also possible.

The next item on semaphore queue 330 (if any) may then be provided to the free resource and the wait operation P( ) may again be implemented.

One issue with such systems is that the resource has no information about the task or operation it will process next. The task or operation may fall into a first category, termed a “short running operation” herein, which may merely be a call to a processor, and thus take a short amount of time to process.

Conversely, the task or operation may fall into a second category, termed a “long running operation” herein, which may take a significant time to run, and thus potentially block the resource. For example, a long running operation may be an input or output call, a network call, or other similar operation, where the resource is stalled because it is waiting for the I/O call to finished. This wait may block the resource from performing other operations, and the resource may sit idle waiting for a response to the call, thereby slowing the system, and wasting processing or other system resources.

In one specific use case, when programming using the Ruby programming language, the language utilizes a Global Virtual Machine Lock, also referred to as a Global Interpreter Lock (GIL). This lock ensures thread-safety for the internal structures of the runtime by allowing only one thread to execute the language's bytecode within a single process at any given time. While this simplifies runtime implementation and integration with non-thread-safe native libraries, it fundamentally prevents true parallelism on multi-core processors for central processing unit (CPU)-bound tasks within a single process. Specifically, allowing only a single thread creates a bottleneck when the thread is a long running thread that, for example, waits for external I/O commands to finish.

The specific problem may arise when handling mixed workloads within a single process, particularly in server environments. In this case, short, CPU-Intensive Requests may require active execution time holding the global lock, while long, I/O-Bound Requests may involve waiting for external resources (network, disk, database).

However, merely opening multiple concurrent threads does not provide a solution. Specifically, when a naive concurrent server model (using multiple threads per process) accepts many requests simultaneously under a global lock, this may lead to contention, saturation and inefficiency. The accepting of many requests may lead to contention when multiple threads constantly compete to acquire the single global lock whenever they need to execute code, even for short bursts between I/O waits.

Further, saturation may occur, and the process can become overwhelmed, due to the overhead of context switching and lock contention, which can lead to poor performance and high resource usage. Short, quick requests get stuck behind longer tasks or suffer high latency due to lock contention.

The above may lead to inefficiency because the resources are being poorly utilized.

Similar issues exist in other environments.

### Short Running and Long Running Operation Semaphores

In accordance with embodiments of the present disclosure, methods and systems are provided to use multiple semaphores of different size limits to process heterogeneous server request at high load.

Specifically, embodiments herein employ a more sophisticated concurrency control strategy within each process, explicitly differentiating between lock-holding (CPU-bound) phases and lock-releasing (I/O-bound) phases. It uses two distinct concurrency limiters like semaphores.

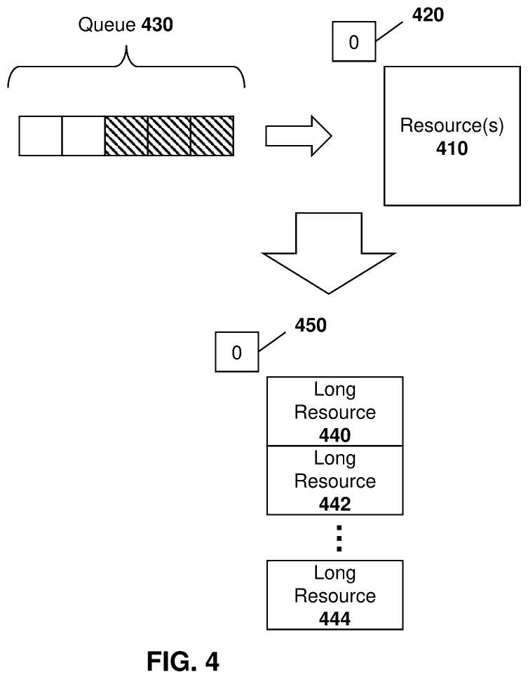

Reference is now made to FIG. 4. As with the embodiments of FIGS. 2 and 3, one or more resources 410 may provide processing for tasks in the system. The example of FIG. 4 shows only a single resource 410, but could be extended to a plurality of resources.

A semaphore 420 acts as a gatekeeper for resource 410. As with the embodiments of FIGS. 2 and 3, semaphore 420 could be a flag, integer, binary digit when only a single resource is used, among other options.

A task could be provided to resource 410. Such task would first perform a wait operation with semaphore 420. If the resource 410 is available, it could start to process the task. Otherwise, the task may be placed on semaphore queue 430.

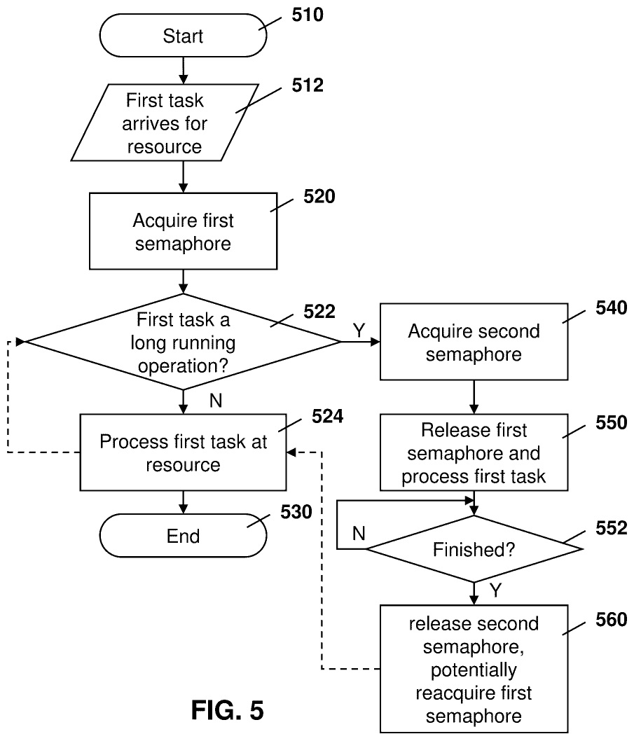

In accordance with the embodiments herein, a check could be made on a task to determine whether the task is a short running operation or a long running operation, as described in more detail with regard to FIG. 5 below.

The system of FIG. 4 includes a plurality of long running operation resources 440, 442, and 444, as well as a second semaphore 450 to gate access to the long running resources.

Therefore, upon determination that a task is a long running operation, the system could perform a wait operation for the second semaphore 450, and once a resource 440, 442 or 444 is obtained, a signal or up operation could be performed on semaphore 420 to release resource 410.

Thereafter, once the long running operation is complete, a wait operation on semaphore 420 could be performed and a signal or up operation could be performed for semaphore 450 to release the resource to allow completion of the task.

In some cases, only the signal or up operation could be performed on semaphore 450 without a corresponding wait operation. This may occur, for example, when the long running operation is the end of a task.

While the embodiment of FIG. 4 does not provide for a semaphore queue for semaphore 450, in some cases such semaphore queue could be provided. Further, in some cases, the system could provide more long resources than short running resources.

Reference is now made to FIG. 5. In particular, the process starts at block 510 and proceeds to block 512 in which a first task arrives for a resource. For example, the resource could be resource 410 from the example of FIG. 4.

Based on the receipt of the first task, the process proceeds to block 520 in which a first semaphore is acquired. For example, this may involve performing a wait operation P( ) for the first semaphore. As will be appreciated by those skilled in the art, the wait operation may, for example, decrement the semaphore, and thus may not block the resource. In this case, if the semaphore is less than zero after the decrement, the process may block the thread until a resource is released. Conversely, if after the decrement the semaphore is greater than or equal to zero, the process may complete wait operation having acquired the semaphore and may release the thread from the semaphore.

Once the resource is acquired, the process proceeds to block 522 in which a check is made to determine if the first task belongs in a first category or second category of task.

The task or operation may fall into a first category, termed a “short running operation” herein, which may for example be a call to a processor, and thus take a short amount of time to process.

Conversely, the task or operation may fall into a second category, termed a “long running operation” herein, which may take a significant time to run, and thus potentially block the resource.

The check at block 522 may be based on various factors.

In one case, the check at block 522 may look for a flag within the code of the task. For example, when the task is programmed, a programmer may insert a flag to indicate that the task is a long running task. In this case the first task may start to be processed before the flag is discovered in some cases.

In some cases, the code for the task may be passed through a parsing algorithm to determine whether any of the code could be considered a long running operation. The factors for the parsing algorithm to consider tasks to be long running operation may be predetermined, and may include network operations, calls to other computing devices, I/O tasks, among others.

In some cases, the parsing may determine that the code is processor bound, and thus is a short-running operation.

In some cases, the check may be based on parsing the task and comparing the task to previously defined long or short running operations. Examples may include a slow disk read function, calling a network stack function, among other options

The factors for the parsing algorithm may in some cases be determined based on optimization algorithms over time, for example using a machine learning model.

Other options are possible.

Thus, the check at block 522 could include a parsing algorithm to parse the task.

In some cases, the check at block 522 could use the amount of time the task has used resource 410, and a threshold may be set. Thus, for example, if the task has used a resource for less than the threshold time, it may be considered a short running operation, while if the time the task has used the resource exceeds the threshold, then the task may be considered a long running operation.

In some cases, the check may be based on a defined sequence of events. For example, if a call for information is made first to a cache, and an indication of a cache miss is received back, then the information may need to be obtained from another source, and the task may be considered a long running operation. Other such sequence of events could also be used for the check at block 522.

In some cases, the check at block 522 may use a combination of the above factors.

Other options for the check at block 522 are possible.

Further, in some embodiments, the check at block 522 may occur before the first semaphore is acquired at block 520.

Based on block 522, the server determines the nature of the task after it has been accepted by the server for resource 410.

From block 522, when it is determined that the task is in the first category (i.e. it is a short running operation), the process proceeds to block 524 in which resource 410 (or one of resources 410 if a plurality exist) may process the first task.

As will be appreciated by those skilled in the art, if the determination at block 522 is based on the length of time the task has taken at the resource 410, then a timer, interrupt or other mechanism may be used to move the process from block 524 back to block 522 after a certain duration. Further, in some cases if the determination at block 522 is based on a flag, the processing at block 524 may discover the flag, and the process may proceed back to block 522. Thus, the processing of the first task may be started, and in some cases part of the first task may be performed, prior to determining that the first task includes a long running operation.

From block 524, once the first task is complete, the process may then proceed to block 530 and end. This may involve a signal or up operation V( ) on semaphore 420 to allow resource 410 to process further tasks.

From block 522, if the first task is determined to be a long running operation, the process may proceed to block 540. At block 540, the process may acquire a second semaphore. For example, this may use a wait operation P( ) on semaphore 450 to determine whether a long_task processing area, such as resources 440, 442 or 444, are free.

Once the second semaphore is acquired, the process may proceed to block 550 in which the first semaphore 420 may be released, thereby allowing the resource 410 to be used for other tasks. Further, the first task, which is a long running operation in this case, may then be processed in the long_task processing area, using resources 440, 442 or 444.

The process may then wait for the long running operation to be finished at block 552, after which the process may proceed to block 560. At block 560, the process may perform a signal or up operation V( ) on the second semaphore 450 to release the resource for future long running operations. In some embodiments this may allow the process to end at block 530 (not shown).

The process at block 560 may further optionally reacquire the first semaphore 420, for example using a wait operation. This may involve putting the first task at the end of a semaphore queue 430 in some cases.

In some cases, the process may reacquire the first semaphore 420 prior to performing the signal or up operation V( ) on the second semaphore 450.

In some cases, the acquiring the first semaphore 420 may place the task at the front of the queue 430 to have the task be the next one processed at the resource 410. However, as will be appreciated by those in the art, if the second semaphore 450 is held while attempting to acquire the first semaphore 420, this could create a blocking situation in some cases.

Specifically, if there are no long_task processing resources left, and the resource 410 has a task that is a long running operation, it may wait for a resource 440, 442 or 444 to become free. At the same time, the resource 440, 442 or 444 may be waiting for resource 410 to become free. This may create a deadlock.

One option to overcome this may be to release the second semaphore 450 prior to trying to acquire resource 410 for the task. In this way, the task within resource 410 may be provided to resource 440, 442 or 444 when the second semaphore 450 is released, freeing resource 410 with semaphore 420. Thereafter, the task that was released from the long_task processing area may reacquire the resource 410.

Other ordering is also possible.

If the first semaphore is reacquired, the process may then proceed to block 524 to perform any short running operations remaining on the first task, prior to the process ending at block 530. The ending of the process at block 530 may further include releasing the first semaphore 420.

In some cases, a further long running operation may be found in the first task during this subsequent processing, resulting in the process proceeding from block 524 back to block 522 and then to block 540 to process the further long running task.

The above therefore provides for methods and systems with an improved concurrency control strategy. In the examples, an execution limiter for primary resources controls access to the main execution context, which may for example be limited in the number of concurrent threads that can be processed, for example through the use of a global lock. Further, secondary processing resources may be used for long running operations, and have a capacity generally greater than the primary resources, where use of such secondary resources may cause the primary resources to be released and allow the process to wait for the long running operation, such as an external I/O operation, to complete. The capacity of the secondary resources may in some cases be tuned based on system resources and load characteristics.

The embodiments described herein provide a trade-off, generally prioritizing overall system latency and stability over minimizing the latency of every single long running operation under heavy load. By limiting the concurrent CPU-bound work, the system may prevent saturation and excessive lock contention. New requests or requests finishing the secondary execution can acquire the primary execution semaphore relatively quickly. This keeps the application responsive and typically reduces the average and tail latency for most requests.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
for a first task:
performing a wait operation to acquire a first semaphore;
after acquiring the first semaphore, determining that the first task includes a long running operation;
responsive to determining that the first task includes the long running operation, performing a wait operation to acquire a second semaphore;
after acquiring the second semaphore, releasing the first semaphore and performing the long running operation; and
responsive to completion of the long running operation, releasing the second semaphore.

2. The computer-implemented method of claim 1, further comprising:
prior to determining that the first task includes a long running operation, beginning the first task.

3. The computer-implemented method of claim 2, wherein beginning the first task includes performing at least a portion of the first task.

4. The computer-implemented method of claim 3, wherein performing the at least a portion of the first task consists of performing one or more short running operations.

5. The computer-implemented method of claim 4, wherein the one or more short running operations are processor-bound operations.

6. The computer-implemented method of claim 1, further comprising:
reacquiring the first semaphore for completing the first task upon release of the second semaphore; and
after completing the first task, releasing the first semaphore.

7. The computer-implemented method of claim 6, wherein completing the first task includes performing at least a portion of the first task.

8. The computer-implemented method of claim 7, wherein performing the at least a portion of the first task includes performing one or more short running operations.

9. The method of claim 1, wherein the long running operation is an input or output bound operation.

10. The method of claim 1, wherein the first task consists of the long running operation.

11. The method of claim 1, wherein that the first task includes a long running operation is determined based on a flag indicating that the first task includes the long running operation.

12. The method of claim 1, wherein determining that the first task includes a long running operation includes determining that the first task includes calls to external computing devices.

13. The method of claim 1, wherein the determining that the first task includes a long running operation includes determining that the first task has taken a greater than threshold amount of time.

14. The method of claim 6, wherein the reacquiring the first semaphore places the first task at an end of a queue for the first semaphore.

15. The method of claim 1, wherein the computer-implemented method is performed on a web server.

16. A computing device comprising:
a processor; and
memory, wherein the computing device is configured to:
for a first task:
perform a wait operation to acquire a first semaphore;
after acquiring the first semaphore, determine that the first task includes a long running operation;
responsive to determining that the first task includes the long running operation, perform a wait operation to acquire a second semaphore;
after acquiring the second semaphore, release the first semaphore and perform the long running operation; and
responsive to completion of the long running operation, release the second semaphore.

17. The computing device of claim 16, wherein the computing device is further configured to, prior to determining that the first task includes a long running operation, begin the first task.

18. The computing device of claim 17, wherein the computing device is configured to begin the first task by performing at least a portion of the first task.

19. The computing device of claim 18, wherein the performing the at least a portion of the first task consists of performing one or more short running operations.

20. A non-transitory computer readable medium for storing instruction code, which, when executed by a processor of a computing device, cause the computing device to:
for a first task:
perform a wait operation to acquire a first semaphore;
after acquiring the first semaphore, determine that the first task includes a long running operation;
responsive to determining that the first task includes the long running operation, perform a wait operation to acquire a second semaphore;
after acquiring the second semaphore, release the first semaphore and perform the long running operation; and
responsive to completion of the long running operation, release the second semaphore.
